(19) United States
(12) Patent Application Publication
(10) Pub. No.: US 2022/0373069 A1
(43) Pub. Date: Nov. 24, 2022

(54) IMPELLER WITH STAKED BLADES AND TORQUE CONVERTER INCLUDING IMPELLER WITH STAKED BLADES

(71) Applicant: Schaeffler Technologies AG & Co. KG, Herzogenaurach (DE)

(72) Inventors: Diego Alvarez, San Andrés Cholula (MX); Jesus Maus, Puebla pue (MX); Omar Yair Guerra, Puebla (MX); Jorge Omar Gonzalez, Tehuacan (MX)

(73) Assignee: Schaeffler Technologies AG & Co. KG, Herzogenaurach (DE)

(21) Appl. No.: 17/325,336

(22) Filed: May 20, 2021

(51) Int. Cl. F16H 41/26; F16H 41/28

(52) U.S. Cl. CPC F16H 41/26; F16H 41/28

(57) ABSTRACT

A torque converter, including: a cover arranged to receive torque; an impeller and a turbine. The impeller includes an impeller shell non-rotatably connected to the cover and a plurality of impeller blades. The impeller shell includes an interior surface, and defines a plurality of first indentations in the interior surface. Each impeller blade in the plurality of impeller blades including a first tab disposed in a respective first indentation. The turbine is in fluid communication with the impeller and includes a turbine shell and turbine blades fixedly connected to the turbine shell. The first tab is fixedly secured to the impeller shell by a respective first portion of a material forming the impeller shell; or a respective first portion of a material forming the impeller shell contacts the first tab and overlaps the first tab in a first axial direction parallel to an axis of rotation of the torque converter.

### TECHNICAL FIELD

The present disclosure relates to an impeller with blades fixed by staking and a torque converter including the impeller with blades fixed by staking.

### BACKGROUND

It is known to use brazing material to fix impeller blades to an impeller shell. However, brazing adds to the complexity of fabricating the impeller and can result in splatter of brazing material, which adversely impacts the performance and service life of the impeller.

### SUMMARY

According to aspects illustrated herein, there is provided an impeller for a torque converter, including: an impeller shell including an interior surface and defining a first indentation in the interior surface; and a blade including a first tab disposed in the first indentation. The first tab is fixedly secured to the impeller shell by a first portion of a material forming the impeller shell.

According to aspects illustrated herein, there is provided a torque converter, including: a cover arranged to receive torque; an impeller and a turbine. The impeller includes an impeller shell non-rotatably connected to the cover and a plurality of impeller blades. The impeller shell includes an interior surface, and defines a plurality of first indentations in the interior surface. Each impeller blade in the plurality of impeller blades including a first tab disposed in a respective first indentation. The turbine is in fluid communication with the impeller and includes a turbine shell and at least one turbine blade fixedly connected to the turbine shell, The first tab is fixedly secured to the impeller shell by a respective first portion of a material forming the impeller shell; or a respective first portion of a material forming the impeller shell contacts the first tab and overlaps the first tab in a first axial direction parallel to an axis of rotation of the torque converter.

According to aspects illustrated herein, there is provided a method of assembling an impeller, comprising: inserting a first tab of each blade, included in a plurality of blades of the impeller, in a respective first indentation defined by an interior surface of a shell of the impeller; contacting the interior surface with a first curved edge of said each blade, the first curved edge extending from the first tab; displacing a respective first portion of a material forming the impeller shell; overlapping the first tab with the respective first portion of the material; and fixing the first tab to the impeller shell with the respective first portion of the material.

### BRIEF DESCRIPTION OF THE DRAWINGS

Various examples are disclosed with reference to the accompanying schematic drawings in which corresponding reference symbols indicate corresponding parts, in which:

FIG. 1 is a front isometric view of an example impeller with staked blades;

FIG. 2 is a front view of the impeller shell shown in FIG. 1 prior to staking the blades;

FIG. 3 is a detail of a radially outer indentation shown in FIG. 2;

FIG. 4 is a detail of a radially inner indentation shown in FIG. 2;

FIG. 5 is a side view of a blade shown in FIG. 1, prior to installation;

FIG. 6 is an isometric view of a blade shown in FIG. 1 prior to staking;

FIG. 7 is a partial front isometric view of the impeller shown in FIG. 1;

FIG. 8 is a detail of a radially outer indentation and blade shown in FIG. 1;

FIG. 9 is a detail of a radially inner indentation and blade shown in FIG. 1;

FIG. 10 is a cross-sectional view generally along line 10-10 in FIG. 6;

FIG. 11 is a cross-section, cut by a circular arc centered on an axis of rotation of the impeller shown in FIG. 1, of a middle indentation shown in FIG. 2;

FIG. 12 is a front isometric view of an example impeller with staked blades;

FIG. 13 is a front view of the impeller shell shown in FIG. 12 prior to insertion of blades;

FIG. 14 is a rear isometric view of the impeller shown in FIG. 12;

FIG. 15 is a side view of a blade shown in FIG. 12, prior to installation;

FIG. 16 is a front isometric view of an example impeller with staked blades;

FIG. 17 is a rear view of the impeller shell shown in FIG. 16;

FIG. 18 is an isometric view of a blade shown in FIG. 16;

FIG. 19 is a rear view of the impeller shown in FIG. 16;

FIG. 20 is a partial cross-sectional view of an example torque converter with the impeller shown in FIG. 1;

FIG. 21 is a partial cross-sectional view of an example torque converter with the impeller shown in FIG. 12; and

FIG. 22 is a partial cross-sectional view of an example torque converter with the impeller shown in FIG. 16.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices, or materials similar or equivalent to those described herein can be used in the practice or testing of the disclosure

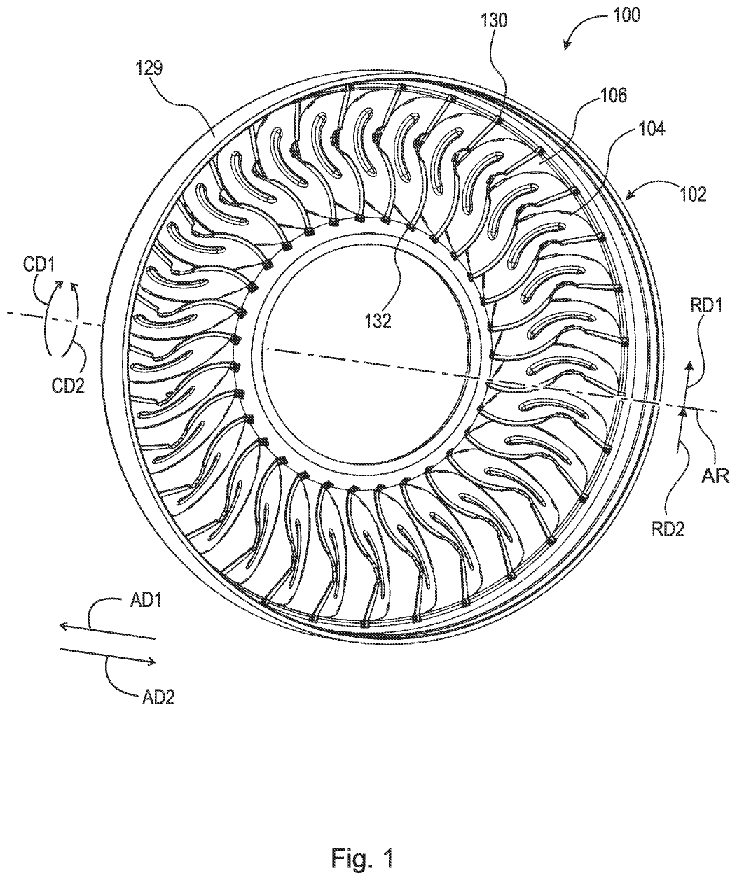

FIG. 1 is a front isometric view of example impeller 100 with staked blades.

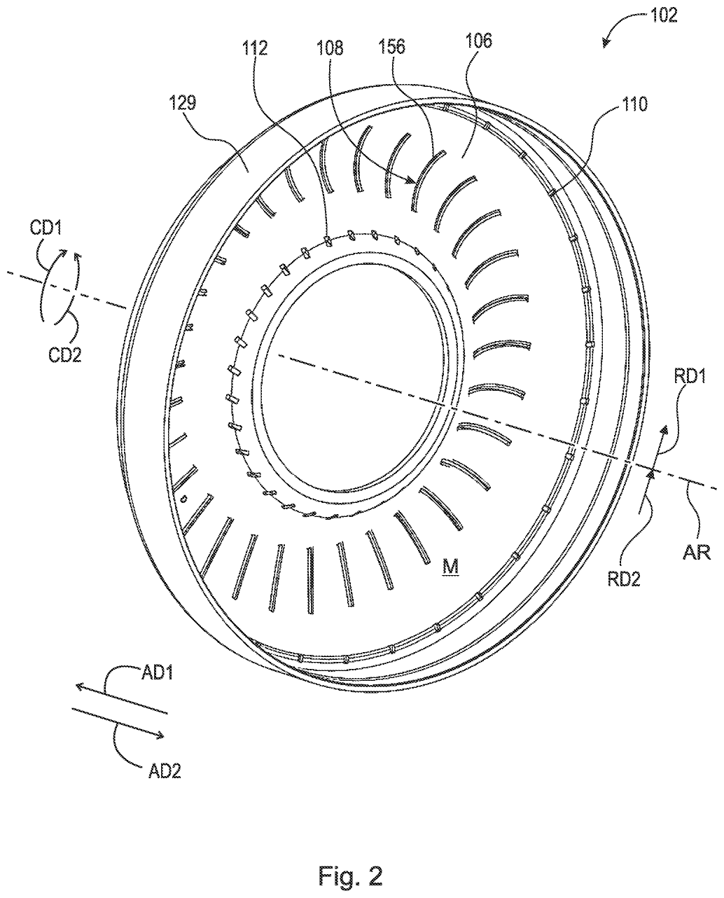

FIG. 2 is a front view of impeller 100 shell shown in FIG. 1 prior to staking the blades.

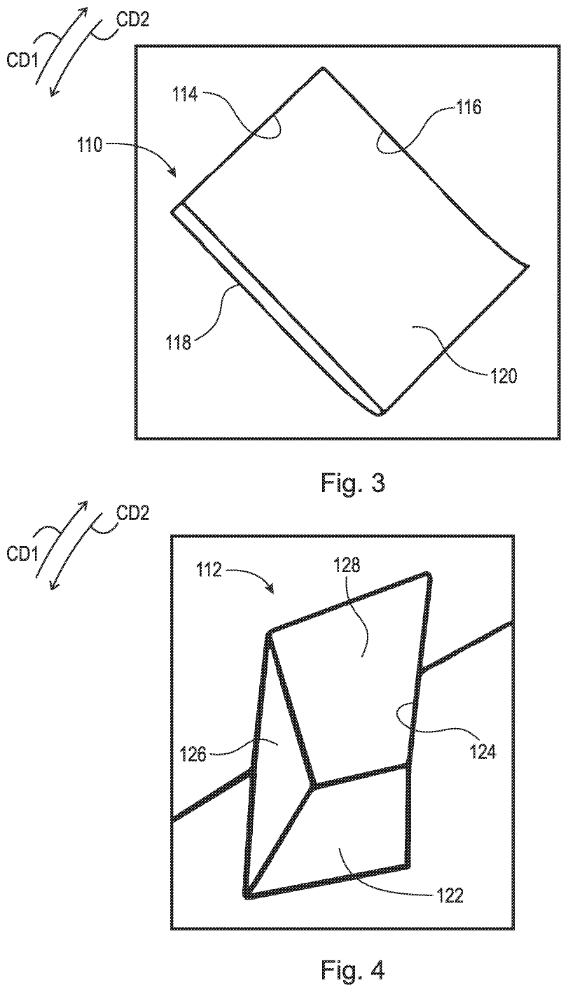

FIG. 3 is a detail of a radially outer indentation shown in FIG. 2.

FIG. 4 is a detail of a radially inner indentation shown in FIG. 2. The following should be viewed in light of FIGS. 1 through 4. Impeller 100 for a torque converter includes impeller shell 102 and blades 104. Impeller shell 102 includes interior surface 106. Impeller shell 102 defines, in interior surface 106: middle indentations 108; radially outer indentations 110, and radially inner indentations 112. Indentations 110 are defined by impeller shell 102 as follows: in radially outer direction RD1 (orthogonal to axis of rotation AR of impeller shell 100) by wall 114; in circumferential direction CD1 (around axis AR) by wall 116; in circumferential direction CD2 (opposite direction CD1) by wall 118; and in axial direction AD1 (parallel to axis AR) by wall 120. Indentations 112 are defined by impeller shell 102 as follows: in radially inner direction RD2 (opposite direction RD1) by wall 122; in circumferential direction CD1 by wall 124; in circumferential direction CD2 by wall 126; and in axial direction AD1 by wall 128.

Indentations 108, 110, and 112 do not extend through impeller shell 102 to exterior surface 129 of impeller shell 102. For example: walls 114, 116, 118, and 120 do not form protrusions in exterior surface 129; and walls 122, 124, 126, and 128 do not forms protrusions in surface 129.

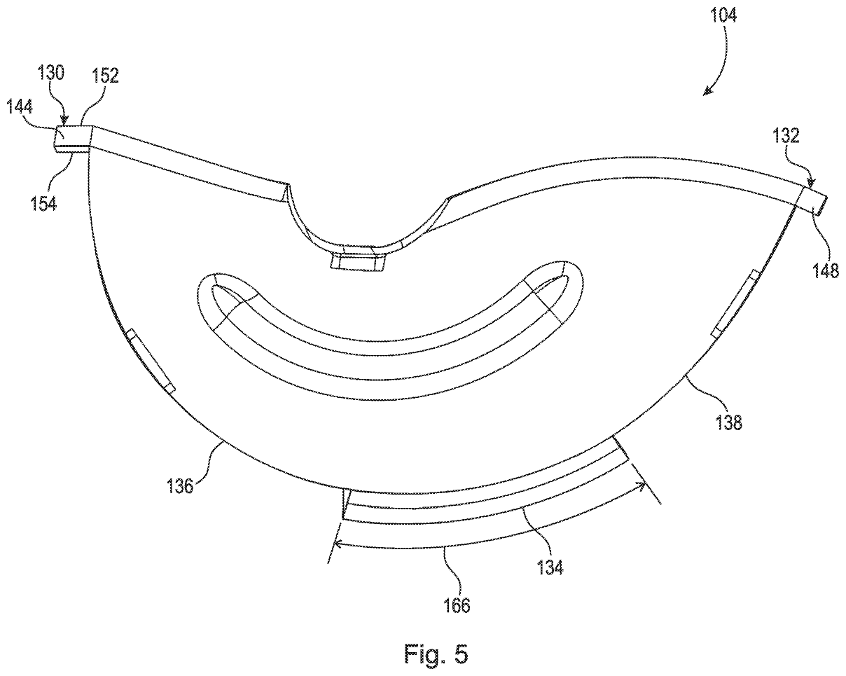

FIG. 5 is a side view of a blade 104 shown in FIG. 1, prior to installation.

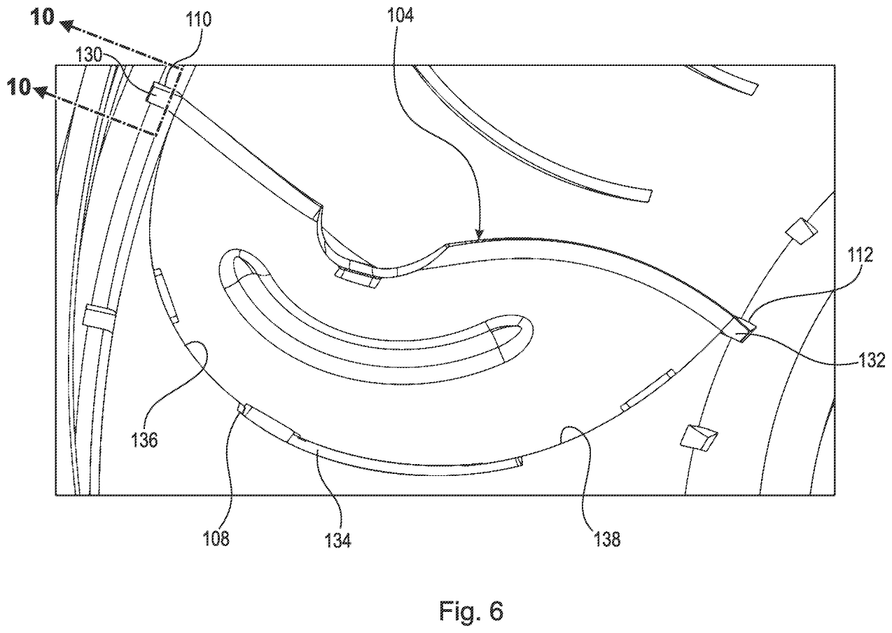

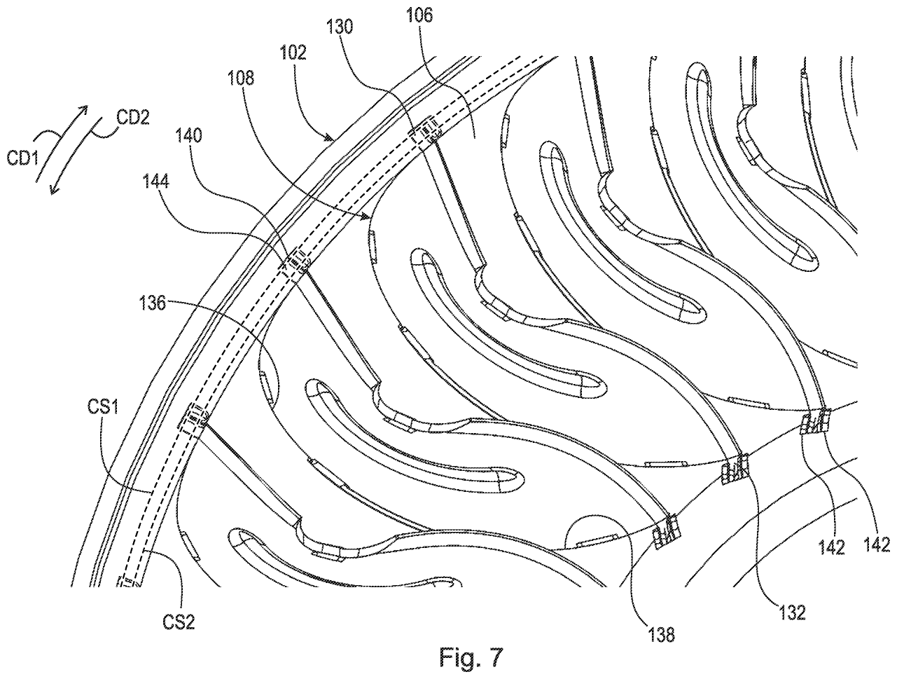

FIG. 6 is an isometric view of blade 104 shown in FIG. 5, prior to staking. The following should be viewed in light of FIGS. 1 through 6. Blade 104 includes: tab 130; tab 132; tab 134; curved edge 136; and curved edge 138. Tabs 130 are disposed in indentations 110. Tabs 132 are disposed in indentations 112, Tabs 134 are disposed in indentations 108. Edge 136 connects tabs 130 and 134 and contacts interior surface 106. Edge 138 connects tabs 132 and 134 and contacts interior surface 106. Tabs 130 form the radially outermost portion of blade 104 when installed in impeller 100; and tabs 132 form the radially innermost portion of blade 104 when installed in impeller 100.

FIG. 7 is a partial isometric view of the impeller shown in FIG. 1.

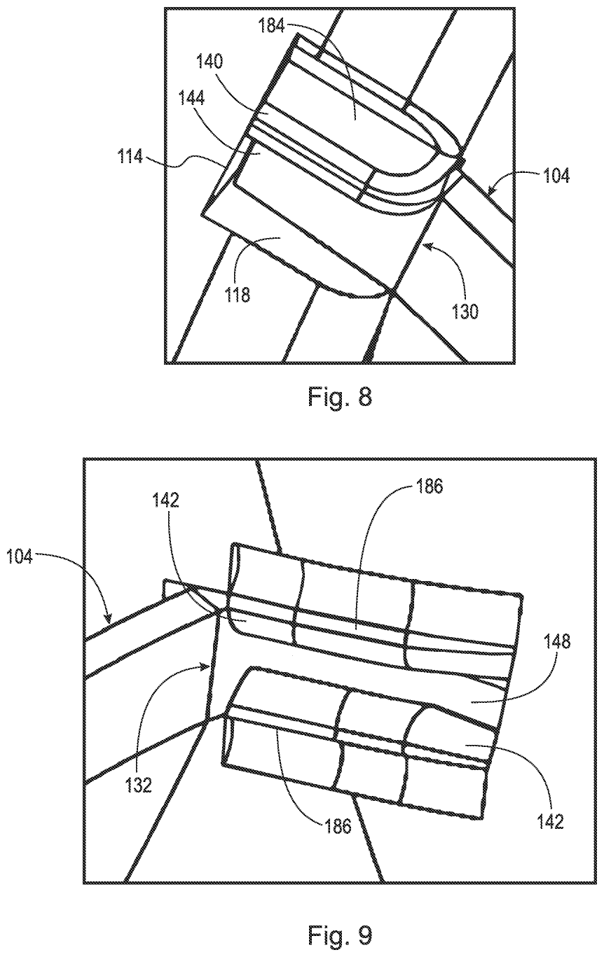

FIG. 8 is a detail of a radially outer indentation 110 and blade tab 130 shown in FIG. 1.

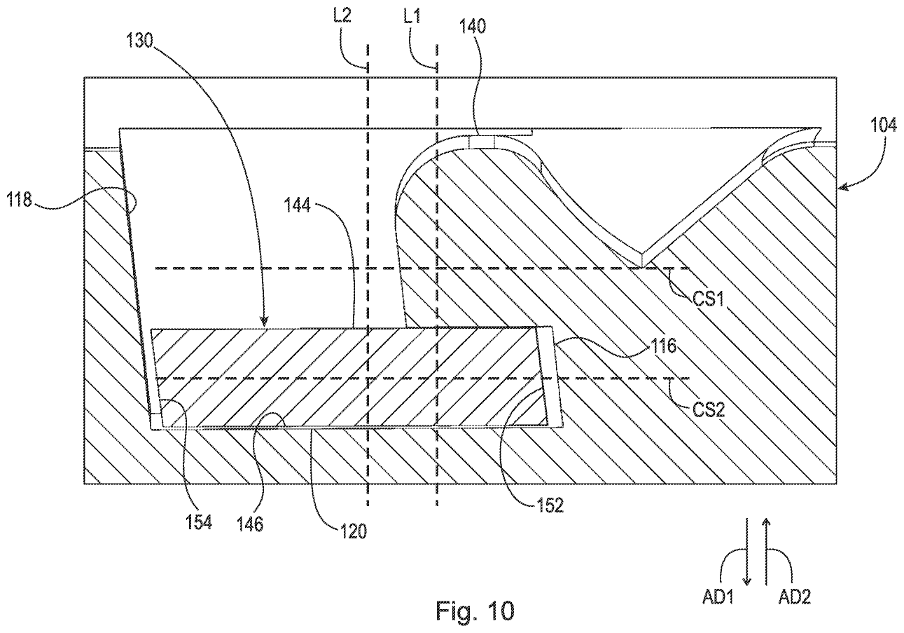

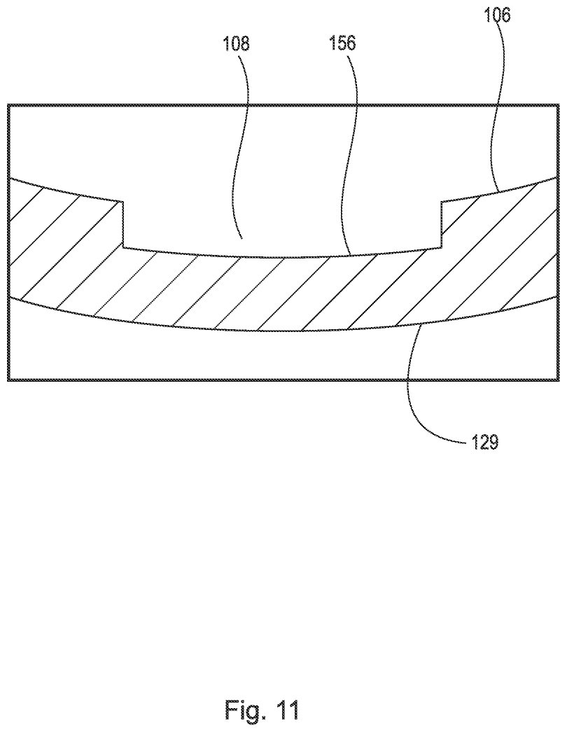

FIG. 9 is a detail of a radially inner indentation 112 and blade tab 132 shown in FIG. 1. The following should be viewed in light of FIGS. 1 through 9. Blades 104 are fixed to impeller shell 102 solely by material M forming impeller shell 102. For example: tabs 130 are fixedly secured to impeller shell 102 solely by material M forming impeller shell 102, for example solely by staked portions 140 of material M; and tabs 132 are fixedly secured to impeller shell 102 solely by material M, for example solely by staked portions 142 of material M. For example: a compressive contact of portions 140 with tabs 130 fixes tabs 130 to impeller shell 102; and a compressive contact of portions 142 with tabs 132 fix tabs 132 to impeller shell 102. Fixing tabs 130 and 132 to impeller shell 102 fixed blades 104 to impeller shell 102. For example, impeller 100 is free of a brazing material contacting blades 104 and fixing blades 104, tabs 130 or tabs 132 to impeller shell 102.

Portions 140 overlap tabs 130 in axial direction AD1, and portions 142 overlap tabs 132 in direction AD1, In the example of FIG. 1: each tab 130 is overlapped by a single portion 140; and each tab 132 is overlapped by two portions 142. It is understood that other configurations of portions 140 and 142 are possible including, but not limited to: each tab 130 and each tab 132 being overlapped by a single portion 140 and a single portion 142, respectively; each tab 130 and each tab 132 being overlapped by a two portions 140 and two portions 142, respectively; and each tab 130 and each tab 132 being overlapped by a two portions 140 and one portion 142, respectively.

FIG. 10 is a cross-sectional view generally along line 10-10 in FIG. 6. The following should be viewed in light of FIGS. 1 through 10. Each tab 130 includes: surface 144 facing at least partly in axial direction AD2, opposite direction AD1; and surface 146 facing opposite surface 144 in direction AD1. Portions 140 are in compressive contact with surfaces 144 and urge surfaces 146 into contact with walls 120.

Each tab 132 includes surface 148 facing at least partly in axial direction AD2. Portions 142 are in compressive contact with surfaces 148 and urge tabs 132 into contact with walls 128.

In the example of FIG. 1, hypothetical straight line L1, parallel to axis AR, passes through in sequence: wall 120; surface 146; surface 144; and portion 140. In the example of FIG. 1, hypothetical straight line L2, parallel to axis AR, passes through in sequence: wall 120; surface 146; and surface 144, without passing through portion 140.

In the example of FIG. 1, hypothetical circle segment CS1, centered on axis AR, passes through wall 118 and portion 140, without passing through tab 130. In the example of FIG. 1, hypothetical circle segment CS2, centered on axis AR, passes through in sequence: wall 116; surface 152 of tab 130 facing direction CD1; surface 154 of tab 130 facing direction CD2; and wall 118, without passing through portion 140.

FIG. 11 is a cross-section, cut by a circular arc centered on an axis of rotation AR of impeller 100 shown in FIG. 1, of a middle indentation 108 shown in FIG. 2. The following should be viewed in light of FIGS. 1 through 11. Impeller shell 102 includes walls 156 defining indentations 108. As seen in FIG. 11, walls 156 do not result in protrusions or bulges in exterior surface 129. For example, walls 156 do not extend far enough from interior surface 106 in direction AD1 to cause bulging of surface 129.

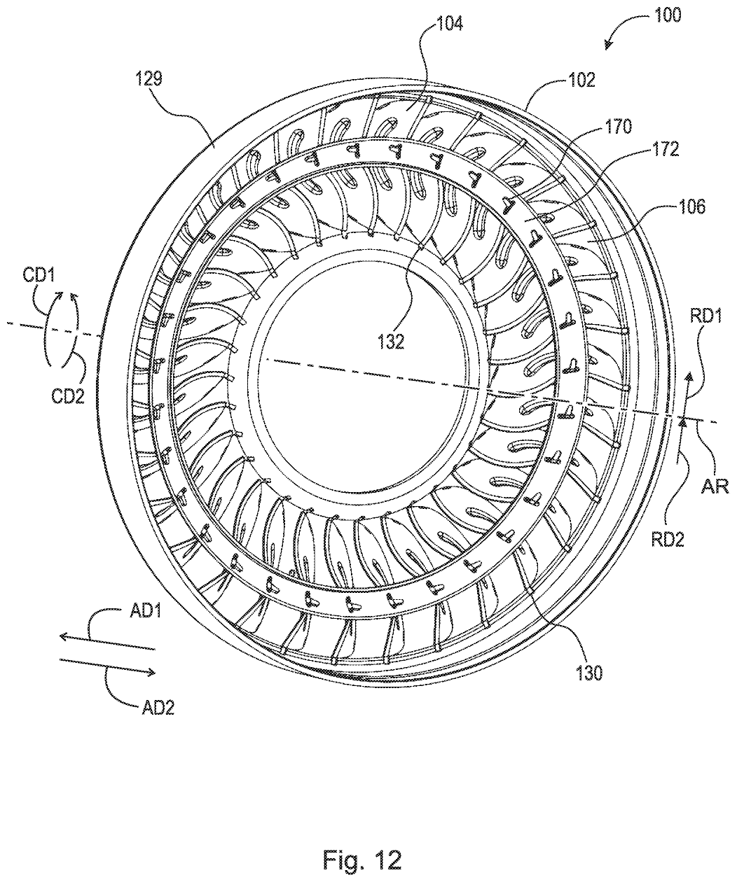

FIG. 12 is a front isometric view of example impeller 100 with staked blades 104.

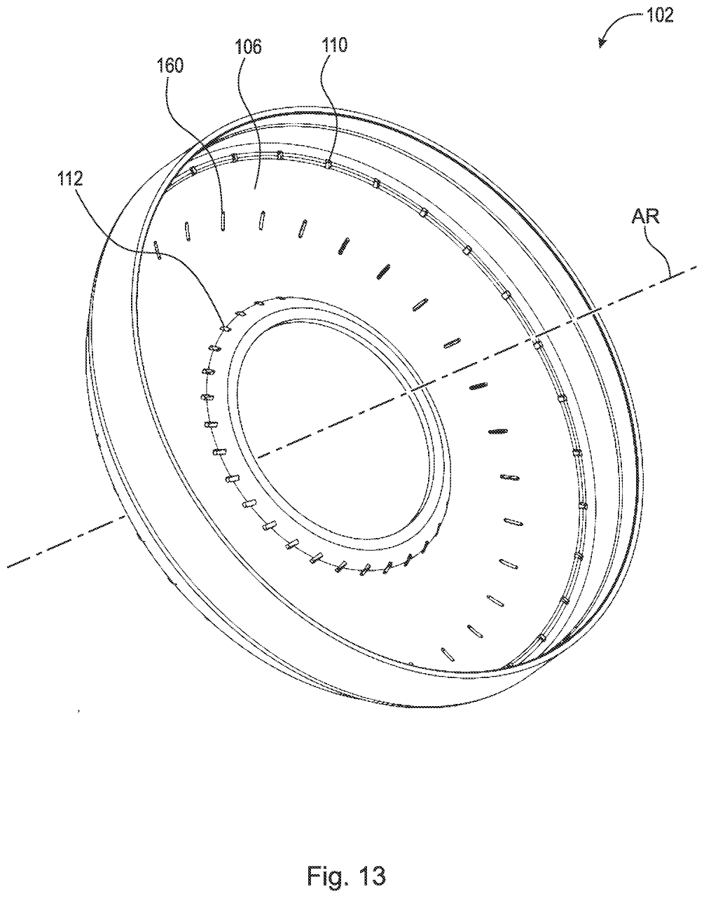

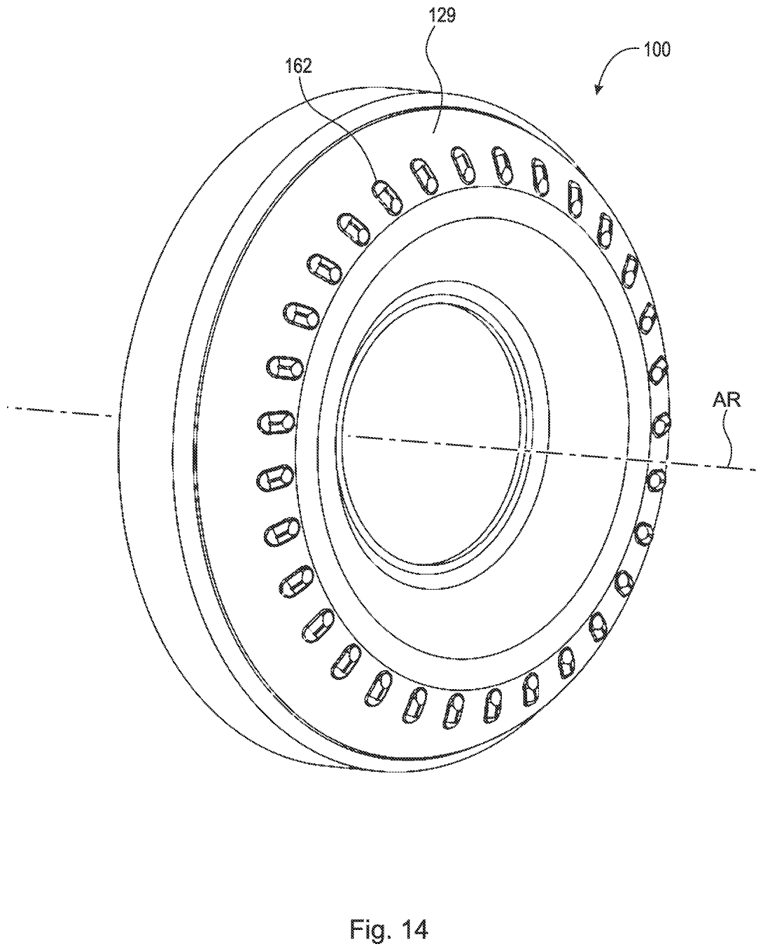

FIG. 13 is a front isometric view of impeller shell 102 shown in FIG. 12.

FIG. 14 is a rear isometric view of impeller 100 shown in FIG. 12.

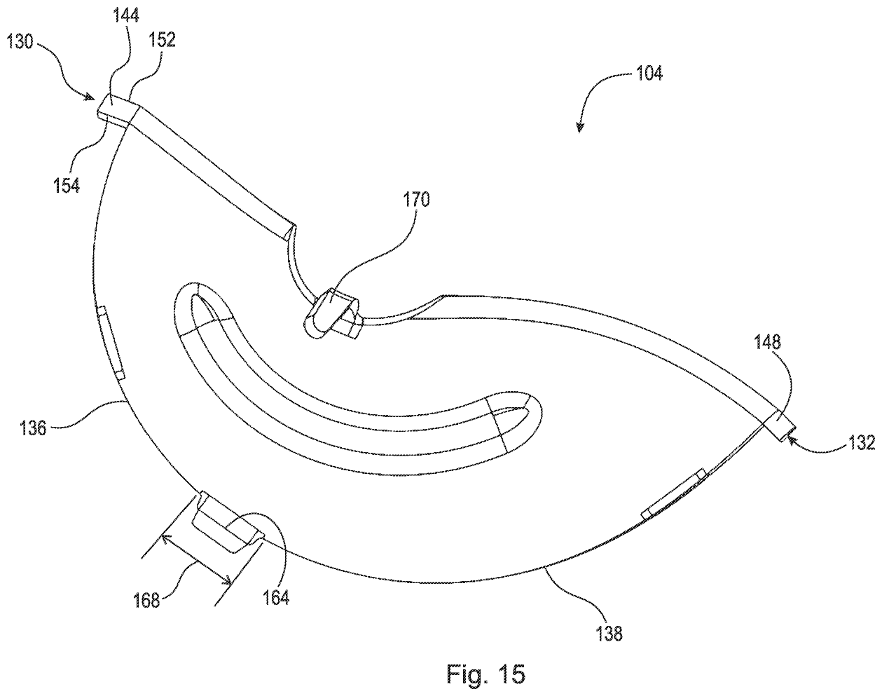

FIG. 15 is a side view of a blade 104 shown in FIG. 12, prior to installation. The discussion for impeller 100 shown in FIG. 1 is applicable to impeller 100 shown in FIG. 12, except as noted. In FIG. 12, middle indentations 108 are replaced by indentations 160, which form protrusions 162 extending outward from exterior surface 129 of impeller shell 102. As shown in FIG. 15, tabs 164 replace tabs 134 on blade 104. In the example of FIGS. 1 and 12, extent 166 between edge 136 and 138 for blade 104 shown in FIG. 5 is greater than extent 168 between edges 136 and 138 for blade 104 shown in FIG. 15. In the example of FIG. 12, blades 104 include core ring tabs 170 which are inserted through core ring 172 to fix blades 104 to core ring 172.

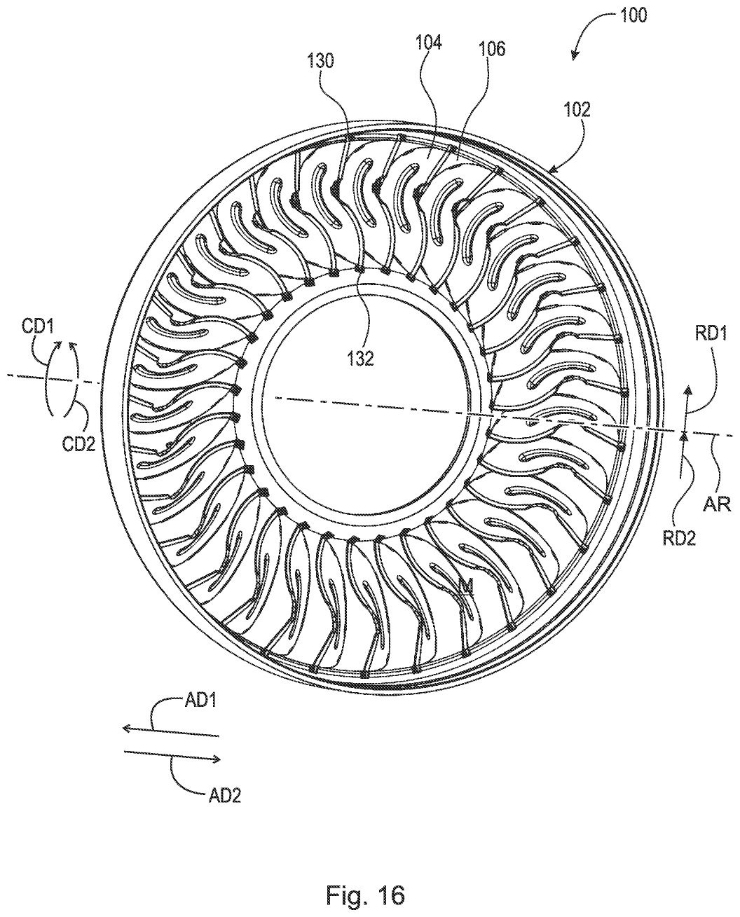

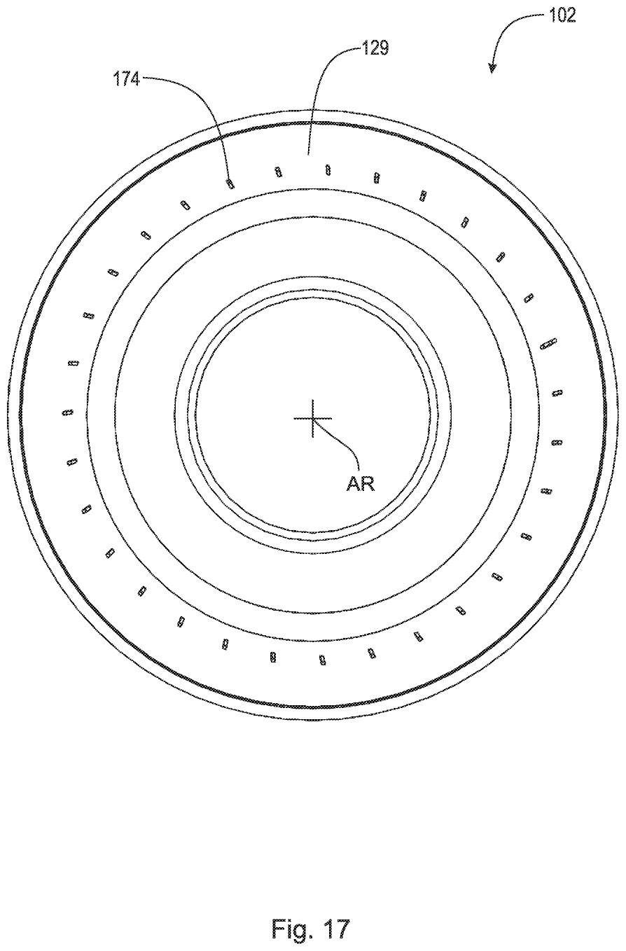

FIG. 16 is a front isometric view of example impeller 100 with staked blades 104.

FIG. 17 is a rear view of impeller shell 102 shown in FIG. 16.

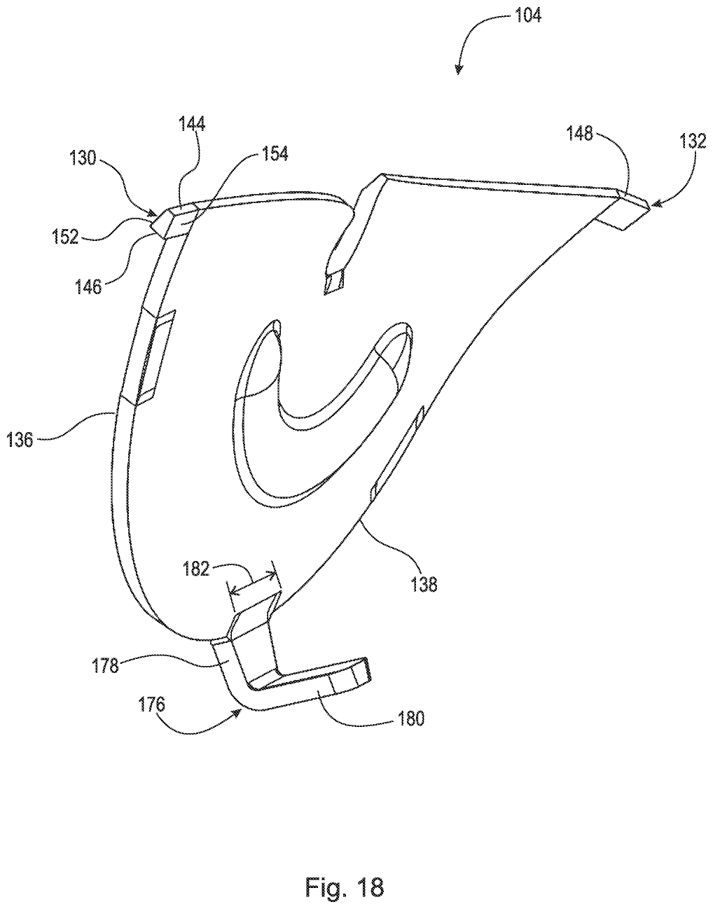

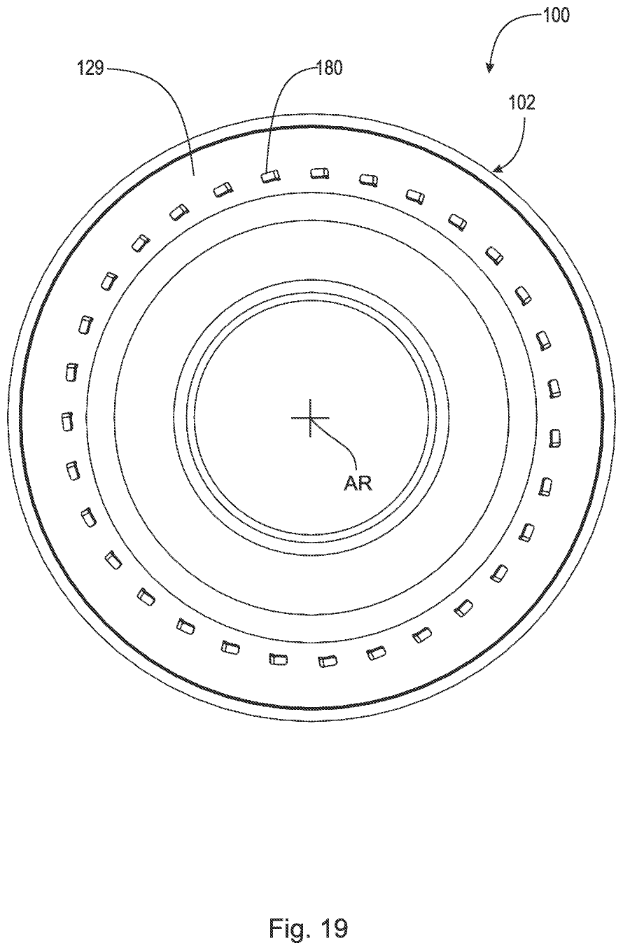

FIG. 18 is an isometric view of a blade 104 shown in FIG. 16.

FIG. 19 is a rear view of impeller 100 shown in FIG. 16, The discussion for impeller 100 shown in FIG. 1 is applicable to impeller 100 shown in FIG. 16, except as noted. In the example of FIG. 16, middle indentations 108 are replaced by slots 174 passing through impeller shell 102 and connecting interior surface 106 and exterior surface 129. As shown in FIG. 18, tabs 176 replace tabs 134 on blade 104. Portions 178 of tabs 176 are disposed in slots 174 and portions 180 of tabs 176 are pressed into contact with exterior surface 129. In the example of FIGS. 1 and 16, extent 166 between edge 136 and 138 for blade 104 shown in FIG. 5 is greater than extent 182 between edges 136 and 138 for blade 104 shown in FIG. 18.

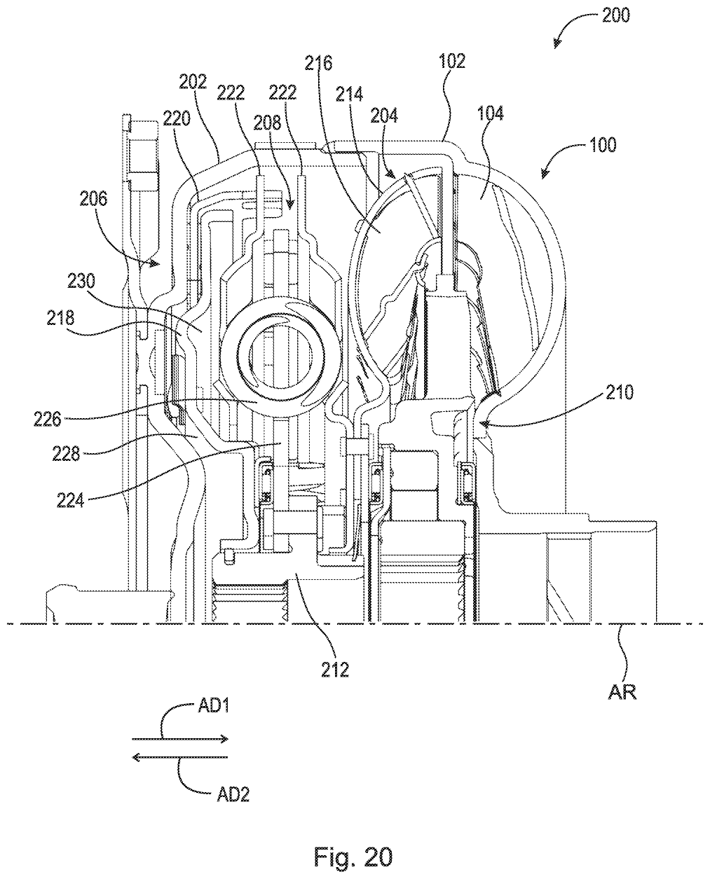

FIG. 20 is a partial cross-sectional view of example torque converter 200 with impeller 100 shown in FIG. 1. The following should be viewed in light of FIGS. 1 through 11 and 20. Torque converter 200 includes: impeller 100 as shown in FIG. 1; cover 202 arranged to receive rotational torque and non-rotatably connected to impeller shell 102; turbine 204; lock-up clutch 206; vibration damper 208; stator 210 located between impeller 100 and turbine 204; and output 212 arranged to non-rotatably connect to a transmission input shaft (not shown). Turbine 204 includes turbine shell 214 and at least one turbine blade 216 fixedly connected to shell 214. Clutch 206 includes axially displaceable piston plate 218 and clutch plate 220. Damper 208 includes: non-rotatably connected cover plates 222; output flange 224 non-rotatably connected to output 212; and at least one spring 226 engaged with plates 222 and flange 224. Cover plates 222 are non-rotatably connected to clutch plate 220 and turbine shell 214.

By “non-rotatably connected” components, we mean that components are connected so that whenever one of the components rotates, all the components rotate; and relative rotation between the components is precluded. Radial and/or axial movement of non-rotatably connected components with respect to each other is possible. Components connected by tabs, gears, teeth, or splines are considered as non-rotatably connected despite possible lash inherent in the connection. The input and output elements of a closed clutch are considered non-rotatably connected despite possible slip in the clutch. The input and output parts of a vibration damper, engaged with springs for the vibration damper, are not considered non-rotatably connected due to the compression and unwinding of the springs. Without a further modifier, the non-rotatable connection between or among components is assumed for rotation in any direction. However, the non-rotatable connection can be limited by use of a modifier, For example, “non-rotatably connected for rotation in circumferential direction CD1,” defines the connection for rotation only in circumferential direction CD1.

For a torque converter mode of torque converter 200, in which torque from cover 202 is transmitted to impeller 100, plate 218 is displaceable, by fluid pressure in chamber 228, in direction AD1 to disengage clutch plate 220 from cover 202. For a lock-up mode of torque converter 200, in which torque from cover 202 is transmitted to damper 208 through clutch 206, plate 218 is displaceable, by fluid pressure in chamber 230, in direction AD2 to non-rotatably connect cover 202, clutch plate 220 and cover plates 222.

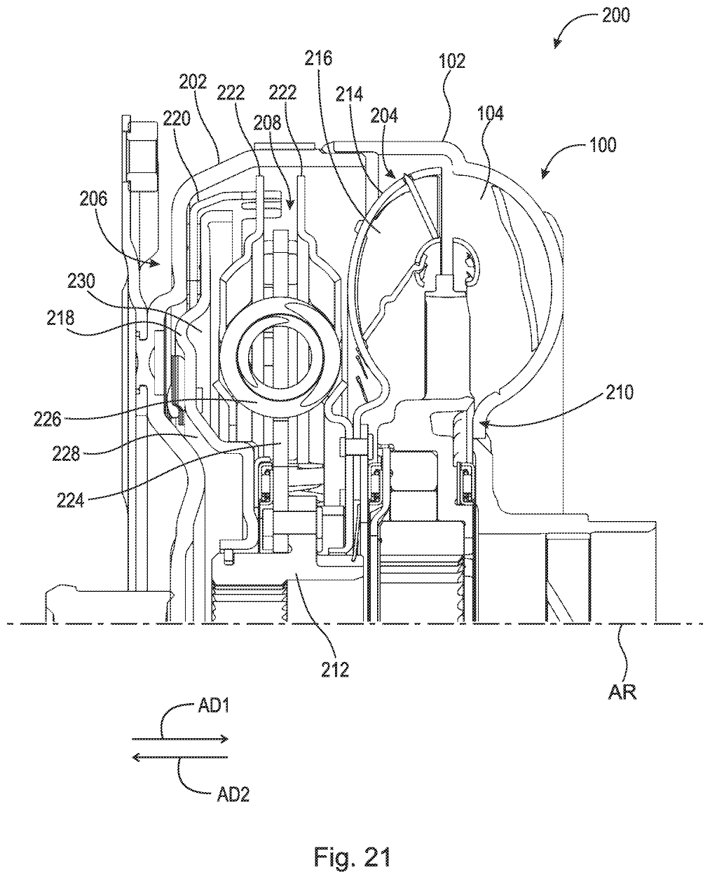

FIG. 21 is a partial cross-sectional view of example torque converter 200 with impeller 100 shown in FIG. 12. The following should be viewed in light of FIGS. 12 through 15 and 21. Torque converter 200 includes: impeller 100 as shown in FIG. 1; cover 202 arranged to receive rotational torque and non-rotatably connected to impeller shell 102; turbine 204; lock-up clutch 206; vibration damper 208; stator 210 located between impeller 100 and turbine 204; and output 212 arranged to non-rotatably connect to a transmission input shaft (not shown). Turbine 204 includes turbine shell 214 and at least one turbine blade 216 fixedly connected to shell 214. Clutch 206 includes axially displaceable piston plate 218 and clutch plate 220. Damper 208 includes: non-rotatably connected cover plates 222; output flange 224 non-rotatably connected to output 212; and at least one spring 226 engaged with plates 222 and flange 224. Cover plates 222 are non-rotatably connected to clutch plate 220 and turbine shell 214.

For a torque converter mode of example torque converter 200, in which torque from cover 202 is transmitted to impeller 100, plate 218 is displaceable, by fluid pressure in chamber 228, in direction AD1 to disengage clutch plate 220 from cover 202. For a lock-up mode of torque converter 200, in which torque from cover 202 is transmitted to damper 208 through clutch 206, plate 218 is displaceable, by fluid pressure in chamber 230, in direction AD2 to non-rotatably connect cover 202, clutch plate 220 and cover plates 222.

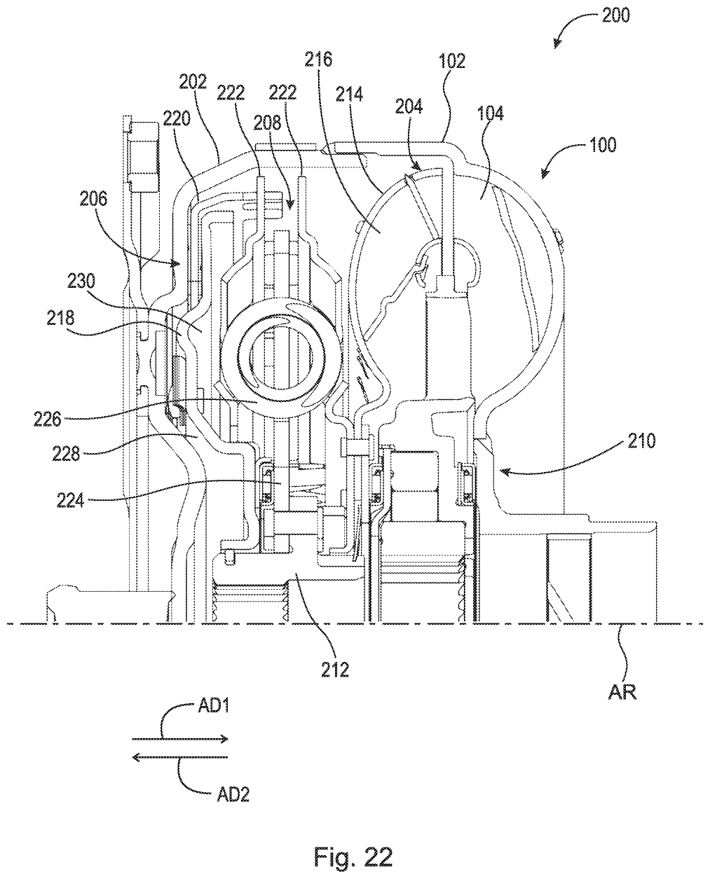

FIG. 22 is a partial cross-sectional view of torque converter 200 with impeller 100 shown in FIG. 16. The following should be viewed in light of FIGS. 16 through 19 and 22. Torque converter 200 includes: impeller 100 as shown in FIG. 1; cover 202 arranged to receive rotational torque and non-rotatably connected to impeller shell 102; turbine 204; lock-up clutch 206; vibration damper 208; stator 210 located between impeller 100 and turbine 204; and output 212 arranged to non-rotatably connect to a transmission input shaft (not shown). Turbine 204 includes turbine shell 214 and at least one turbine blade 216 fixedly connected to shell 214. Clutch 206 includes axially displaceable piston plate 218 and clutch plate 220. Damper 208 includes: non-rotatably connected cover plates 222; output flange 224 non-rotatably connected to output 212; and at least one spring 226 engaged with plates 222 and flange 224. Cover plates 222 are non-rotatably connected to clutch plate 220 and turbine shell 214.

For a torque converter mode of torque converter 200, in which torque from cover 202 is transmitted to impeller 100, plate 218 is displaceable, by fluid pressure in chamber 228, in direction AD1 to disengage clutch plate 220 from cover 202. For a lock-up mode of torque converter 200, in which torque from cover 202 is transmitted to damper 208 through clutch 206, plate 218 is displaceable, by fluid pressure in chamber 230, in direction AD2 to non-rotatably connect cover 202, clutch plate 220 and cover plates 222.

The following should be viewed in light of FIGS. 1 through 19. The following describes a method of assembling impeller 100 for a torque converter. Although the method is presented as a sequence of steps for clarity, no order should be inferred from the sequence unless explicitly stated. A first step inserts tabs 130 of blades 104 into indentations 110 in shell 102. A second step contacts interior surface 106 of shell 102 with curved edges 136 of blades 104. A third step displaces material M to form portions 140. A fourth step overlaps tabs 130 with portions 140 and contacts tabs 130 with portions 140. A fifth step fixedly connects tabs 130 to impeller shell 102 with portions 140.

A sixth step inserts tabs 132 of blades 104 into indentations 112 in shell 102. A seventh step contacts interior surface 106 with curved edge 138. An eighth step displaces material M to form portions 142. A ninth step overlaps tabs 132 with portions 142 and contacts tabs 132 with portions 142. A tenth step fixedly connects tabs 132 to impeller shell 102 with portions 142.

In an example embodiment, an eleventh step connects blades 104 to each other solely with shell 102. In an example embodiment, a twelfth step: inserts tabs 134 into indentations 108; or inserts tabs 164 into indentations 160 and connects tabs 170 to core ring 172; or passes tabs 176 through slots 174 and contacts surface 129 with portions 180.

In an example embodiment, displacing material M to form portions 140 includes forming divots 184, continuous with portions 140, in material M. In an example embodiment, displacing material M to form portions 142 includes forming divots 186, continuous with portions 142, in material M.

In an example embodiment, fixedly connecting tabs 130 to impeller shell 102 with portions 140 includes fixedly connecting tabs 132 to impeller shell 102 solely with portions 140. In an example embodiment, fixedly connecting tabs 132 to impeller shell 102 with portions 142 includes fixedly connecting tabs 132 to impeller shell 102 solely with portions 142.

In an example embodiment, fixedly connecting tabs 130 to impeller shell 102 with portions 140 and fixedly connecting tabs 132 to impeller shell 102 with portions 142 includes fixedly connecting blades 104 to impeller shell 102 solely with portions 140 and 142.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE CHARACTERS

AD1 axial direction
AD2 axial direction
AR axis of rotation
CD1 circumferential direction
CD2 circumferential direction
CS1 circle segment
CS2 circle segment
L1 line
L2 line
M material, shell
100 impeller
102 impeller shell
104 impeller blade
106 interior surface, impeller shell
108 indentation, impeller shell
110 indentation, impeller shell
112 indentation, impeller shell
114 wall
116 wall
118 wall
120 wall
122 wall
124 wall
126 wall
128 wall
130 tab
132 tab
134 tab
136 curved edge
138 curved edge
140 portion, shell
142 portion, shell
144 surface, tab
146 surface, tab
148 surface, tab
152 surface, tab
154 surface, tab
156 wall, shell
160 indentation
162 protrusion
164 tab
166 extent
168 extent
170 core ring tab
172 core ring
174 slot
176 tab
178 portion, tab 176
180 portion, tab 176
182 extent
184 divot
186 divot

1. An impeller for a torque converter, comprising:
an impeller shell:
including an interior surface; and,
defining a first indentation in the interior surface; and,
a blade including a first tab disposed in the first indentation, the first tab fixedly secured to the impeller shell by a first portion of a material forming the impeller shell.

2. The impeller of claim 1, wherein:
the first tab is fixedly secured to the impeller shell solely by a contact of the first portion of the material forming the impeller shell with the first tab; or,
the impeller shell defines a central opening through which an axis of rotation of the impeller passes, and the first portion of the material forming the impeller shell overlaps the first tab in an axial direction parallel to the axis of rotation.

3. The impeller of claim 1, wherein:
the impeller shell defines a second indentation in the interior surface;
the blade includes a second tab disposed in the second indentation; and,
the second tab is fixedly secured to the impeller shell solely by a contact of a second portion of the material forming the impeller shell with the second tab; or,
the impeller shell defines a central opening through which an axis of rotation of the impeller passes, and the second portion of the material forming the impeller shell overlaps the second tab in an axial direction parallel to the axis of rotation.

4. The impeller of claim 1, wherein:
the impeller shell defines a central opening through which an axis of rotation of the impeller passes;
the impeller shell includes a first wall defining the first indentation in a first axial direction parallel to the axis of rotation;
the first tab includes:
a second wall in contact with the first wall; and,
a third wall facing at least partly in a second axial direction, opposite the first axial direction; and,
the first portion of the material forming the impeller shell is in contact with the third wall.

5. The impeller of claim 4, wherein:
a first hypothetical straight line, parallel to the axis of rotation, passes through, in sequence: the first wall, the second wall, the third wall, and the first portion of the material forming the impeller shell; and,
a second hypothetical straight line, parallel to the axis of rotation, passes through, in sequence: the first wall, the second wall, and the third wall without passing through the first portion of the material forming the impeller shell.

6. The impeller of claim 1, wherein:
the impeller shell defines a central opening through which an axis of rotation of the impeller passes;
the impeller shell includes:
a first wall defining the first indentation in a first circumferential direction around the axis of rotation; and,
a second wall defining the first indentation in a second circumferential direction, opposite the first circumferential direction;
a first hypothetical circle segment, centered on the axis of rotation, passes through the first wall and the first portion of the material forming the impeller shell without passing through the first tab; and,
a second hypothetical circle segment, centered on the axis of rotation, passes through in sequence, the first wall, the first tab, and the second wall without passing through the first portion of the material forming the impeller shell.

7. The impeller of claim 1, wherein:
the impeller shell:
includes an exterior surface; and,
defines a second indentation in the interior surface and a third indentation in the interior surface; and,
the blade includes:
a second tab disposed in the second indentation and fixedly connected to the impeller shell with a second portion of the material forming the impeller shell;
a third tab disposed in the third indentation;
a first curved edge connecting the first tab and the third tab and in contact with the interior surface;
a second curved edge connecting the third tab and the second tab and in contact with the interior surface.

8. The impeller of claim 7, wherein:
the impeller shell includes:
an exterior surface; and,
a wall defining the third indentation in the interior surface; and,
the wall does not define a protrusion extending from the exterior surface of the impeller shell.

9. The impeller of claim 1, wherein the impeller is free of a brazing material in contact with the blade and the impeller shell.

10. A torque converter, comprising:
a cover arranged to receive torque;
an impeller including:
an impeller shell non-rotatably connected to the cover, the impeller shell:
including an interior surface; and,
defining a plurality of first indentations in the interior surface; and,
a plurality of impeller blades, each impeller blade in the plurality of impeller blades including a first tab disposed in a respective first indentation; and,
a turbine in fluid communication with the impeller and including a turbine shell and at least one turbine blade fixedly connected to the turbine shell, wherein:
the first tab is fixedly secured to the impeller shell by a respective first portion of a material forming the impeller shell; or,
a respective first portion of a material forming the impeller shell contacts the first tab and overlaps the first tab in a first axial direction parallel to an axis of rotation of the torque converter.

11. The torque converter of claim 10, wherein:
the impeller shell defines a plurality of second indentations in the interior surface of the impeller shell;
said each impeller blade includes a second tab disposed in a respective second indentation; and,
the second tab is fixedly secured to the impeller shell solely by a contact of a respective second portion of the material forming the impeller shell with the second tab; or,
a respective second portion of the material forming the impeller shell contacts the second tab and overlaps the second tab in in a first axial direction parallel to an axis of rotation of the torque converter.

12. The impeller of claim 10, wherein:
the impeller shell includes an exterior surface; and,
said each blade includes:
a second tab; and,
a first curved edge in contact with the interior surface of the impeller shell and connecting the first tab and the second tab; and,
the impeller shell defines a plurality of second indentations, and the second tab is disposed in a respective second indentation; or,
the impeller shell defines a plurality of slots connecting the interior surface of the impeller shell with the exterior surface of the impeller shell, and the second tab passes through a respective slot and is in contact with the exterior surface of the impeller shell.

13. The torque converter of claim 12, wherein:
the impeller shell defines the plurality of second indentations;
the impeller shell includes:
an exterior surface; and,
a plurality of walls, each wall defining a respective second indentation; and,
said each wall fails to define a protrusion extending from the exterior surface of the impeller shell.

14. The torque converter of claim 10, wherein:
the impeller shell defines:
a plurality of second indentations in the interior surface of the impeller shell; and,
a plurality of third indentation in the interior surface of the impeller shell; and,
said each impeller blade includes
a second tab disposed in a respective second indentation and fixedly secured to the impeller shell solely by a contact of a respective second portion of the material forming the impeller shell with the second tab;
a third tab disposed in a respective third indentation;
a first curved edge in contact with the interior surface and connecting the first tab and the third tab; and,
a second curved edge in contact with the interior surface and connecting the third tab and the second tab.

15. The torque converter of claim 10, wherein the plurality of impeller blades are connected to each other solely by the impeller shell.

16. The torque converter of claim 10, wherein:
a first hypothetical straight line, parallel to the axis of rotation, passes through the first tab and the respective first portion of the material forming the impeller shell; and,
a second hypothetical straight line, parallel to the axis of rotation, passes through the first tab without passing through the respective first portion of the material forming the impeller shell.

17. A method of assembling an impeller, comprising:
inserting a first tab of each blade, included in a plurality of blades of the impeller, in a respective first indentation, the respective first indentation defined by a shell of the impeller, in an interior surface of the shell of the impeller;
contacting the interior surface with a first curved edge of said each blade., the first curved edge extending from the first tab;
displacing a respective first portion of a material forming the impeller shell;
overlapping the first tab with the respective first portion of the material; and,
fixing the first tab to the impeller shell with the respective first portion of the material.

18. The method of claim 17, further comprising:
inserting a second tab of said each blade in a respective second indentation in the interior surface of the shell of the impeller, the respective second indentation defined by the shell of the impeller;
contacting the interior surface with a second curved edge of said each blade, the second curved edge extending from the second tab;
displacing a respective second portion of the material forming the impeller shell;
overlapping the second tab with the respective second portion of the material; and,
fixing the second tab to the impeller shell with the respective second portion of the material.

19. The method of claim 18, further comprising:
inserting a third tab of said each blade in a respective third indentation in the interior surface of the shell of the impeller, the respective third indentation defined by the shell of the impeller, wherein:
the third tab is directly connected to the first curved edge and to the second curved edge;
the respective third indentation is defined, in an axial direction parallel to an axis of rotation of the impeller, by a respective wall of the shell; and,
the respective wall of the shell fails to define a protrusion in an exterior surface of the shell.

20. The method of claim 17, further comprising:
connecting the plurality of blades to each other solely by the impeller shell,
